(19) United States
(12) Patent Application Publication
(10) Pub. No.: US 2013/0167119 A1
(43) Pub. Date: Jun. 27, 2013

(54) APPARATUS AND METHOD FOR SUPPORTING SOFTWARE DEVELOPMENT FOR VEHICLE

(71) Applicant: Electronics and Telecommunications Research In, Daejeon (KR)

(72) Inventors: Byung-Yun LEE, Daejeon-si (KR); Young-Il CHOI, Daejeon-si (KR); Byung-Sun LEE, Daejeon-si (KR)

(73) Assignee: Electronics and Telecommunications Research Institute, Daejeon (KR)

(21) Appl. No.: 13/678,617

(22) Filed: Nov. 16, 2012

(30) Foreign Application Priority Data
Dec. 23, 2011 (KR) 10-2011-0141221

(51) Int. Cl. G06F 9/44

(52) U.S. Cl. 717/121

(57) ABSTRACT

An apparatus and method for supporting development of software for vehicles which may classify functions required from a vehicle-IT development viewpoint as components and use the classified components in order to easily develop vehicle-IT application software such as navigation software or a black box are provided. The apparatus for supporting development of software for vehicles includes a common interface that provides a communication connection with a vehicle application service development device for developing vehicle-IT-related application services, and a common component management unit that manages a common component for configuring functional data of a vehicle used in developing the vehicle-IT-related application services as a component to be reused, and provides the common component to the vehicle application service development device through the common interface in response to a request from the vehicle application service development device.

### CROSS-REFERENCE TO RELATED APPLICATION

This application claims the benefit under 35 U.S.C. §119(a) of Korean Patent Application No. 10-2011-0141221, filed on Dec. 23, 2011, the entire disclosure of which is incorporated herein by reference for all purposes.

### BACKGROUND

1. Field

The following description relates to an apparatus and method for developing software for a vehicle, and more particularly, to an apparatus and method for easily developing vehicle-IT application software such as navigation, a black box, or the like.

2. Description of the Related Art

With the rapid development of semiconductor and computer technologies, parts manufacturers that produce electrical and electronic products for vehicles have produced new products with improved performance within a very short time period, and therefore automobile manufacturers have to frequently improve software for vehicles. Faced with the challenge of effectively developing complex and large-scale software for vehicles, automobile manufacturers acutely feel the need for an integrated software platform which has been standardized. The integrated software platform is a development environment that enables object-oriented and easily scalable software to be manufactured by describing operation environments, communication schemes, ECU (electronic control unit) constraints, and the like of each software module in a unified way.

The core idea of the integrated software platform for vehicles is to enable software for vehicles to be independently developed from a base hardware architecture. This would allow automobile manufacturers to treat software development and hardware development separately and upgrade electrical and electronic parts while keeping pace with hardware development, which has been rapidly advancing.

In addition, software developers can concentrate on implementing functions of application programs, and therefore higher quality software can be implemented.

Development of the integrated software platform for vehicles is too difficult task for individual manufacturers, and therefore cooperation of the entire automobile industry is required.

In practice, these movements have actively progressed centering on European automobile industries which lead automotive markets, and AUTOSAR (AUTomotive Open Software ARchitecture) development partnership was founded in June, 2003, with the aim to establish an open standard for software architecture for automobiles. However, the integrated software platform for vehicles provided by the AUTOSAR defines standards for software components which directly operate in an ECU of a vehicle, and these standards may raise the technical barrier faced by European automobile manufacturers.

As an example of related art, Korean Patent Application No. 10-2009-0107400 was filed on May 11, 2012 on behalf of Daegu Gyeongbuk Institute of Science & Technology with the title “Driver Position Control System Based on AUTOSAR Standard Platform and Design Method Using the Same”.

### SUMMARY

The following description relates to an apparatus and method for supporting development of software for vehicles, which can classify functions required for vehicle-IT development as components and use the classified components in order to easily develop vehicle-IT application software such as navigation, a black box, or the like.

In one general aspect, there is provided an apparatus for supporting development of software for vehicles, including: a common interface that provides a communication connection with a vehicle application service development device for developing vehicle-IT-related application services; and a common component management unit that manages a common component for configuring functional data of a vehicle used in developing the vehicle-IT-related application services as a component to be reused, and provides the common component to the vehicle application service development device through the common interface in response to a request from the vehicle application service development device.

In another general aspect, there is provided a method for supporting development of software for vehicles, including: managing a common component for configuring functional data of a vehicle used in developing vehicle-IT-related application services as a component to be reused; and providing the common component to a vehicle application service development device for developing the vehicle-IT-related application services in response to a request from the vehicle application service development device.

Other features and aspects will be apparent from the following detailed description, the drawings, and the claims.

### BRIEF DESCRIPTION OF THE DRAWINGS

FIG. 1 is a drawing illustrating a configuration of an apparatus for supporting development of software for vehicles based on a common component for vehicle-IT according to an embodiment of the present invention;

FIG. 2 is a drawing illustrating a data structure of component basic information according to an embodiment of the present invention;

FIG. 3 is a drawing illustrating a structure of detailed information of each component for effective reuse of components according to an embodiment of the present invention;

FIG. 4 is a drawing illustrating a structure of dependence information of components according to an embodiment of the present invention;

FIG. 5 is a flowchart illustrating a method for supporting development of software for vehicles according to an embodiment of the present invention;

FIG. 6 is a flowchart illustrating a method for registering a common component for reuse according to an embodiment of the present invention; and

FIG. 7 is a flowchart illustrating a method for updating a common component according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness. Hereinafter, preferred embodiments of the present invention will be described in detail with reference to accompanying drawings.

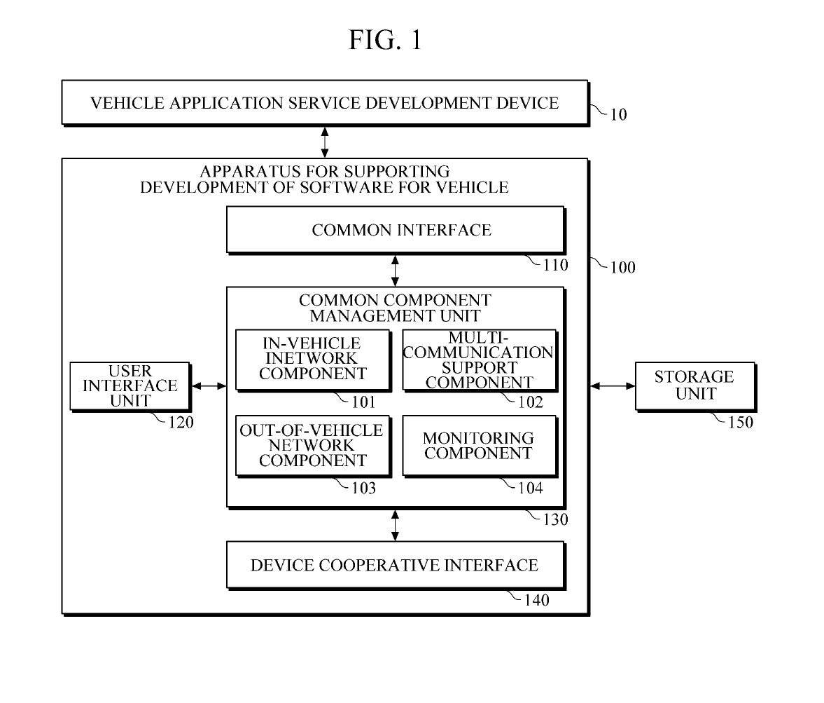

FIG. 1 is a drawing illustrating a configuration of an apparatus for supporting development of software for vehicles based on a common component for vehicle-IT according to an embodiment of the present invention.

The apparatus 100 for supporting development of software for vehicles provides services and functions in conjunction with a vehicle application service development device 10 in component units.

The vehicle application service development device 10 indicates a system that is used by manufacturers which develop vehicle-IT-based combined services and solutions. For example, the vehicle application service development device 10 may be a device that develops or combines services such as eco-driving services, black box application services, vehicle insurance-related services, blind spot application services, and the like.

The apparatus 100 provides platform technology that enables a company for developing the vehicle-IT-based combined services and solutions to readily develop a new application service program without vehicle expertises by reusing a predefined common component to thereby develop a vehicle-based solution at low cost and with high efficiency.

For this, the apparatus 100 effectively manages and configures a component which is newly registered using functions and services of component units.

The component is that a program source file programmed to perform a specific function is defined in an easy-to-use/manage format. The component may be defined using a UML (unified modeling language) file.

The common component is obtained by configuring functional data of a vehicle used in developing the vehicle-IT-related application services as the component.

The common component is proven software in which a software module that is commonly and frequently used by vehicle-IT software developers is provided based on a reusable component to enable the software module to be easily reused.

The common component provides in advance the software module for easily providing various functions to developers for developing vehicle-IT applications from various viewpoints.

A common component management unit 130 may register a component that is newly defined by a user, search for the registered component, and download their own desired components to thereby enable the downloaded components to be reused. Accordingly, it is possible to easily, rapidly, and safely develop the vehicle-IT combined services using the component provided in advance.

Referring to FIG. 1, the apparatus 100 includes a common interface 110, a user interface unit 120, a common component management unit 130, and a device cooperative interface 140, and a storage unit 150.

The common interface 110 provides an interface for a common component for vehicle-IT with respect to the vehicle application service development device 10.

The user interface unit 120 may receive a user input signal and transmit the received input signal to the common component management unit 130.

In addition, the user interface unit 120 may include a data input/output device such as a touch screen, and output data processing results in accordance with the user input signal of the common component management unit 130.

A user that inputs the user input signal may be a user that designs the common component, or a vehicle-IT developer that is a user of the vehicle application service development device 10.

The common component may be reused in a method of updating a common component that is newly developed by a user or a common component that is previously defined.

The common component management unit 130 configures and manages functions necessary for providing the vehicle-IT-related application services in a reusable component format.

The common component according to an embodiment is a component that is used for general purposes by the vehicle-IT application service developers of the vehicle application service development device 10, and may indicate a component deemed reliable by the vehicle application service development device 10 or the user as a result of completing testing and verification of the component.

In contrast, an uncommon component may not be used for general purposes using the common component by a developer, and may indicate a component deemed unreliable because testing and verification was not performed in advance by the common component management unit 130. Here, the description will focus on the common component.

The common component management unit 130 may manage the common component, obtained by configuring the functional data of the vehicle used for developing the vehicle-IT-related application services as the component, to be reused, and provide the common component to the vehicle application service development device 10 through the common interface 110 in response to a request from the vehicle application service development device 10.

The common component management unit 130 may manage information about the component as a component registration simplification file including information describing component-related information, so as to be conveniently used to redefine the information about the component in the future.

When a previously registered component is upgraded to a newer version, the component registration simplification file provides a function of conveniently using the component. When using this function, only a version of a name is changed while information of the existing component is all maintained. Also, information of an existing file may be input in advance when a corresponding file is selected at the time of registering a similar component using a ‘component name.ini’ file automatically generated when component property information, operation information, component dependence information, component explanation, and component reference files, which are information relating to the previously registered component, are initially registered as the component.

A user may correct only portions required to be corrected using this function, and easily register the component. The user may correct only actual version upgrade information using the version upgrade function.

The common component management unit 130 may manage an in-vehicle network component 101, a multi-communication support component 102, an out-of-vehicle network component 103, a monitoring component 104, and the like. Although not shown, the common component management unit 130 may manage various common components such as a virtual vehicle component, a roadside infrastructure cooperative component, and the like.

The in-vehicle network component 101 is a software component that easily provides demands for vehicle-related information for various vehicle types without vehicle expertise.

The in-vehicle network component 101 may include detailed components such as an vehicle information input processing component, a vehicle data analysis file managing component, a vehicle information (engine, transmission, OBD-I, and OBD-II) collecting component, and the like. For example, mileage information for calculating a vehicle's fuel economy and emissions information are calculated by receiving the in-vehicle network component 101, which is one of common components for the vehicle-IT, through the common interface 110 when the vehicle application service development device 10 develops eco-driving services, and therefore software or applications for eco-driving services which can be provided to users may be developed.

The multi-communication support component 102 is a component that supports various wireless communication interfaces such as WAVE (Wireless Access in Vehicular Environment), DSRC (Dedicated Short-Range Communication), WCDMA (Wideband Code Division Multiple Access), WLAN (Wireless LAN), and the like, and provides an optimal network selection function based on a variety of situation-aware elements (for example, signal strength, preference, prices, data transmission rate, positions, speeds, and the like).

The out-of-vehicle network component 103 is a component that provides a communication function for transmitting and receiving data based on a connection with the CDMA network and the WCDMA network, service protocol support between a TSP (telematics service provider) server and a terminal, and a TSP server simulation and security setting function.

The monitoring component 104 is a component that provides in-vehicle network communication data and out-of-vehicle network communication data such as CAN, that is, a terminal-TSP server monitoring function, and a transmission/reception message and log monitoring function.

The virtual vehicle component is a component that provides a test function in a development stage using actual vehicle information before collecting virtual vehicle data such as CAN data to thereby directly install the collected virtual vehicle data in an actual vehicle.

The roadside infrastructure cooperative component is a component that provides a method in which data on roadside infrastructure is provided to another component using a DSRC standard protocol to cooperate with the other component when a variety of roadside infrastructure is required upon development of the vehicle-IT application program.

By providing the common component defined in this manner, the vehicle-IT service developers of the vehicle application service development device 10 may easily carry out development using the defined component, and the component is subjected to a registration process based on user needs, and is managed in the storage unit 150.

The common component management unit 130 registers a new component and updates an existing component in accordance with a user input signal from the user interface unit 120.

The registration of the component is a function for registering a reusable component in a vehicle-IT platform.

The device cooperative interface 140 receives device-related data dependent on a specific device required upon configuration of the component for developing the vehicle-IT-related application services.

As the specific device, a specific vehicle, a communication device used in the specific vehicle, a terminal device for a vehicle, and the like may be used. The device cooperative interface 140 may receive vehicle-related data from the specific vehicle, the communication device used in the specific vehicle, or the terminal device for a vehicle, or from a user through the user interface unit 140.

In a case of a vehicle, since data files to be used in cooperation with the common in-vehicle network component differ according to vehicle manufacturer or vehicle model, the device cooperative interface 140 receives settings for this to provide an appropriate cooperative method.

In a case of the out-of-vehicle network component, the device cooperative interface 140 provides a software driver for device cooperation according to a communication scheme (Bluetooth, wireless LAN, or the like).

The device-related data may include vehicle information for each vehicle type and information about a variety of communication schemes which are information necessary for service development of the vehicle-IT service developer.

The common component provides only API so that developers can easily use required functions, but has to be adapted to a corresponding vehicle or device so as to be actually used.

For example, the device cooperative interface 140 receives data having various types for each company or vehicle from a device to perform the vehicle-IT-related application service so as to obtain mileage information and emissions information for calculating eco-driving services.

The common component management unit 130 may analyze the data received by the device cooperative interface 140 to perform the vehicle-IT-related application service, and transform the common component into function data executable in the device to perform the vehicle-IT-related application service using the data received through the device cooperative interface 140.

The device cooperative interface 140 provides a function for supporting cooperation with respect to individual devices.

The storage unit 150 effectively stores and manages the common component defined in advance and the component newly defined by a user based on reusability.

The common component according to an embodiment may include basic information of the common component, operation information used in the common component, and dependence information indicating a relationship between the common component and another common component.

The common component management unit 110 may classify the operation information used in the common component into a core module for performing a specific function, an output module for providing operations and information about the common component to a GUI (Graphic User Interface), and an external library module including a library used when the specific function is executed in conjunction with an external device, and mange the classified operation information.

A plurality of operations are carried out in a single common component, and the common component provides a variety of functions in accordance with the user's needs. For example, in a case of the in-vehicle network component, operations may be defined to obtain a variety of vehicle information (for example, speed, RPM, steering angle, and the like).

A core module that performs a key role and information that has to be set by a user to perform the core module exist in order to perform a specific function, and are provided through the GUI provided to the component for user's convenience. Accordingly, the GUI provided from the common component may differ from a development environment of a specific user in accordance with an execution environment, and in this case, the user may reuse only a core function of the common component.

In a case of the external library module, a variety of device drivers exist in accordance with hardware characteristics of a device (modem, wireless RAN, etc.) used by a user, and therefore separate management for the device driver is required.

Accordingly, to enable convenient reference and correction by a user, the common component may further include source position information of the core module, source position information of a GUI module, and source position information of the external library module.

In addition, when the related component is classified into a plurality of detailed components, the dependence information indicating a relationship between the common component and another component may further include information indicating a relationship between the common component and the classified detailed component.

According to the apparatus 100, in order to easily develop not the software component that is directly installed in the ECU but the vehicle-IT application software such as navigation software or a black box, functions required from the vehicle-IT development viewpoint are classified as components to be used, so that the vehicle-IT application software is independently defined for a specific vehicle type and vehicle and a communication scheme for external interoperation, and thereby the software developers can concentrate on implementing functions of application programs, yielding high-quality software.

In addition, the apparatus 100 may be easily applied even to an existing vehicle which does not support the AUTOSAR.

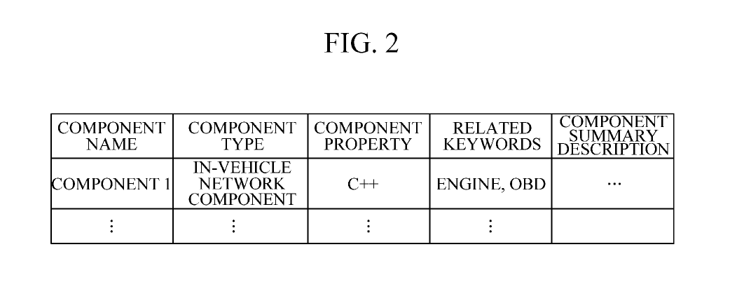

FIG. 2 is a drawing illustrating a data structure of component basic information according to an embodiment of the present invention.

The component basic information required upon input of component information so as to effectively reuse the component may include a component name, a component type, component property, component-related keywords, and a component summary description.

Component type information may include level information of a registered component.

The level information of the component may indicate a mutual level relation between components. In addition, the component type information may indicate types according to functions of components such as the in-vehicle network component and a multi-support component. The component type information may be defined so as to enable the components to be easily searched and used by defining and categorizing a component-related classification system according to the purpose of component creation.

Component type information may include information indicating whether the registered component is a common component which can be shared with other developers.

Through the component type information, reusability of the component can be increased, and intellectual property rights of the developers can be guaranteed.

Component property information may define programming language information (C, C++, java, etc.) of a defined component source for the convenience of developers.

The component-related keywords may include search keywords which can be used to search for a corresponding component.

The component summary description may include summary information about a component which can be used to search for and inquire about the component.

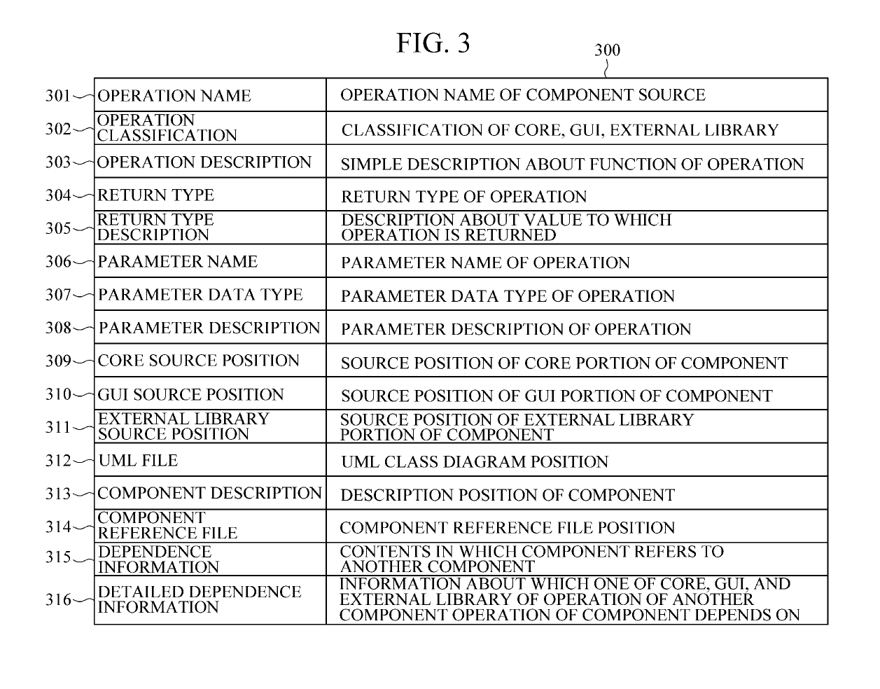

FIG. 3 is a drawing illustrating a structure of detailed information of each component for effective reuse of components according to an embodiment of the present invention.

A data structure 300 of the detailed information of the component may include an operation name 301, operation classification 302, operation description 303, a return type 304, return type description 305, a parameter name 306, a parameter data type 307, parameter description 308, core source position information 309, GUI source position information 310, external library source position information 311, UML file position information n312, component description position information 313, component reference file position information 314, dependence information 315, and detailed dependence information 316.

For the convenience of description, it is assumed that the data structure of FIG. 3 is operation information about a common component whose name is “component 1”.

The operation name 301 is an operation name of a source of the component 1.

When the component 1 includes a plurality of operations, the operation name 310 may include a plurality of operation names of the component 1.

The operation name is, for example, getOBDRequest.

The operation classification 302 indicates classification of an operation of the component 1 as a core module, a GUI module, or an external library module. The operations of the defined component 1 are classified as the core module for performing a specific function of the component 1, an output module for providing operation and information about a common component as a GUI, and the external library module for including a library used when the specific function is performed in conjunction with an external device, and the classified operation is managed.

Each defined operation defines the specific function (for example, in a case of the in-vehicle network component, an operation used to obtain a variety of in-vehicle information (for example, speed, RPM, steering angle, etc.)) in response to a user's request.

In order to perform the unique specific function of the component, there is need for an operation for outputting, to a GUI window, the core module which performs a key role and information or a result value which has to be set by a user to perform the core module, and the operation is provided through the GUI module provided to the component for user convenience.

Accordingly, the GUI module provided from the common component in accordance with an execution environment may differ from a development environment of a specific user, and in this case, the user may reuse only a core function of the common component.

When a variety of device drivers exist in accordance with hardware characteristics of a device (modem, wireless RAN, etc.) used by a user, the external library module has to be defined for each device driver and separately managed to cooperate with the device.

Through the operation classification information, a user of a corresponding component may selectively use only a module suitable for his/her own purposes and development environment.

The operation description 303 includes a simple description portion about a function of the defined operation. The operation description 303 is defined so that the understanding of a user of a corresponding component in the future may be improved.

The return type 304 is a portion that defines parameters returned as a result of performing the corresponding operation.

The return type description 305 is a portion that describes the return type.

The parameter name 306 indicates a name for a parameter that is used in the corresponding operation.

The parameter data type 307 indicates a data type of the parameter that is used in the corresponding operation. For example, an input parameter type of a corresponding operation may be “PID:int”, and an output parameter type may be defined as “string”.

The parameter description 308 describes the parameter that is used in the corresponding operation.

The core source position information 309 indicates a source position of a core module of a corresponding operation.

The GUI source position information 310 indicates a source position of a GUI module of a corresponding operation.

The external library source position information 311 indicates a source position of an external library module of a corresponding operation.

The core source position information 309, the GUI source position information 310, and the external library source position information 311 are defined so as to enable easy reference and correction when a user desires to correct the corresponding operation in the future.

The UML file position information 312 indicates a position of a component-related UML class diagram which is used to design a component.

The UML file position information 312 may be used so as to easily refer to the UML class diagram.

The component description position information 313 indicates a position of the component description.

The component description position information 313 may include description relating to a component-related UML file so as to easily refer to information of the UML class diagram.

The component reference file position information 314 indicates a position of a reference file of a corresponding component. The reference file of the component may include the above-described component registration simplification file.

The dependence information 315 indicates a mutual relationship between a component that is newly defined and managed and a component that is previously defined. That is, the dependence information 315 may indicate referring to another component (for example, a component 2) by the component 1.

The dependence information is information indicating a use relationship between respective components. For example, when a specific developer develops a user-defined component for providing an eco-driving function, which is obtained by reusing an in-vehicle network component of a specific version and a monitoring component, relationships between the respective components may be displayed for the convenience of the developer.

The detailed dependence information 316 is information for managing operations of the components which are classified as the core module, the GUI module, and the external library module, in a detailed manner.

The detailed dependence information 316 is information about which one of a core module, a GUI module, and an external library module of operations of another component the operations of the component depends on.

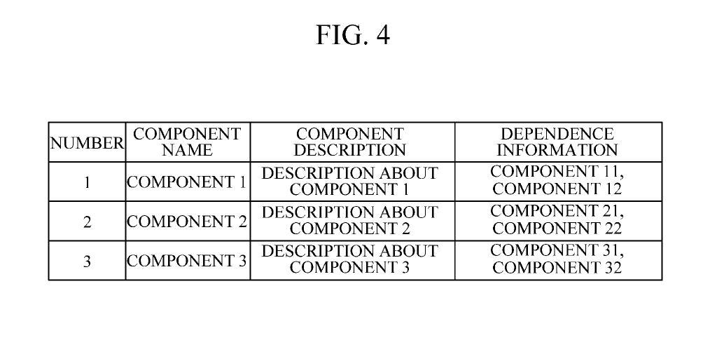

Efficiency of management between common components can be increased using the dependence information 315 and the detailed dependence information 316 between the components. The dependence information 315 and the detailed dependence information 316 may be separately managed as shown in FIG. 4 in order to effectively reuse the component.

FIG. 4 is a drawing illustrating a structure of dependence information of components according to an embodiment of the present invention.

Referring to FIG. 4, dependence information about each component may include a component name, component description, and dependence information.

Referring to FIG. 4, a common component whose name is the component 1 has a dependency relationship with a component 11 and a component 12. This indicates that the component 11 and the component 12 have the dependency relationship using the component 1.

The component 11 included in the dependence information about the component 1 may indicate a core module, a GUI module, or an external library module of a component (for example, a component 2) other than the component 1.

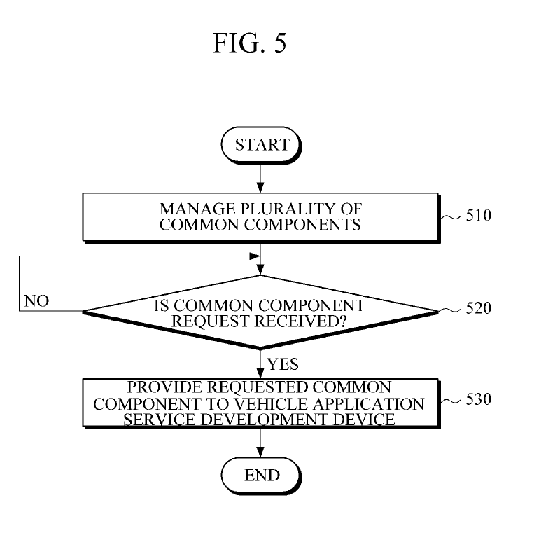

FIG. 5 is a flowchart illustrating a method for supporting development of software for vehicles according to an embodiment of the present invention.

In step 510, the apparatus 100 for supporting development of software for vehicles manages a plurality of common components that configure functional data of a vehicle used to develop vehicle-IT-related application services as a component.

In step 530, when the apparatus 100 receives a signal requesting a specific common component from the vehicle application service development device 10 in step 520, the apparatus 100 provides at least one common component selected in accordance with the signal requesting the specific common component to the vehicle application service development device 30.

In this instance, the apparatus 100 may search for the common component requested from the storage unit (150 of FIG. 1), and provide the common component to the vehicle application service development device 10.

For example, keywords related to the component to be searched for are included in the signal requesting the specific common component, and a component having the related keywords included in the signal requesting the common component is searched for in the storage unit and provided.

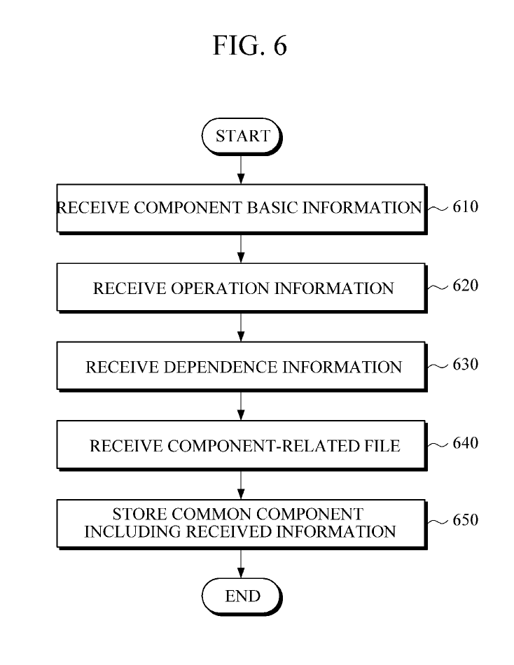

FIG. 6 is a flowchart illustrating a method for registering a common component for reuse according to an embodiment of the present invention.

The apparatus 100 may be registered, stored, and managed in the same manner as that of FIG. 6 for efficient reuse of the component.

In step 610, the apparatus 100 receives common component basic information. The common component basic information may include a component name, component classification information, component property, component related-keywords, and component summary description.

In step 620, the apparatus 100 receives operation information.

In step 630, the apparatus 100 receives dependence information.

A component that is newly defined and managed has a mutual relationship with a component that is previously defined, and detailed dependence information that indicates the relationship may be defined to thereby increase efficiency of management.

The detailed dependence information is classified into a core module, a GUI module, and an external library module and managed in a detailed manner, thereby increasing scalability.

In step 640, the apparatus 100 receives a component-related file. The component-related file may include a component-related description and a component-related document.

In step 650, the apparatus 100 stores a common component including the received common component basic information, the operation information, the dependence information, and the component-related file.

The component that is registered by a user may be registered as a common component after being subjected to testing and verification by the apparatus 100.

The component that is not subjected to the testing and verification by the apparatus 100 may be classified as an uncommon component, and stored separately from the common component.

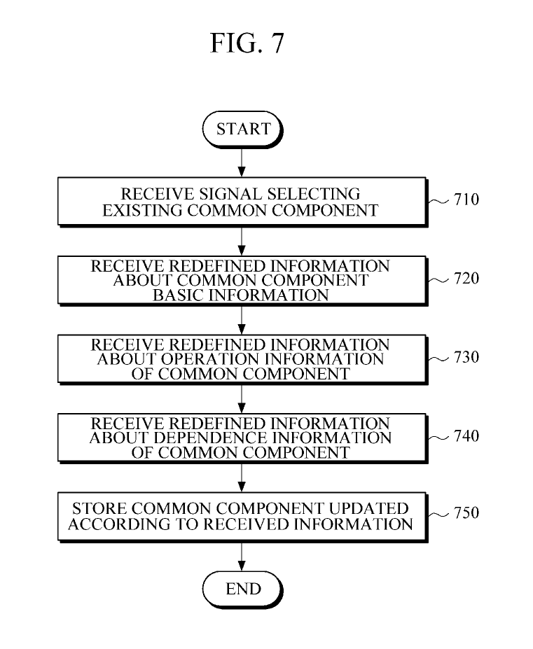

FIG. 7 is a flowchart illustrating a method for updating a common component according to an embodiment of the present invention.

In step 710, the apparatus 100 receives a user input signal for selecting an existing common component desired to be changed, through a user interface.

When the component registration simplification file that is previously defined is searched for, the apparatus 100 may provide the component registration simplification file to a user, thereby providing information about a changeable data structure of a component.

In step 720, the apparatus 100 receives redefined information about the common component basic information through a user interface.

In step 730, the apparatus 100 receives redefined information about operation information of the common component through the user interface.

The operation information used in the common component may include the operation name 301, the operation classification 302, the operation description 303, the return type 304, the return type description 305, the parameter name 306, the parameter data type 307, the parameter description 308, the core source position information 309, the GUI source position information 310, and external library source position information 311, which are shown in FIG. 3.

In step 740, the apparatus 100 receives redefined information about dependence information of the common component through the user interface.

The redefined information about the dependence information may include redefined information about the dependence information 315 and the detailed dependence information 316, which are shown in FIG. 3.

Operations 720, 730, and 740 may be selectively performed in accordance with a user input signal.

In step 750, the apparatus 100 stores the common component that is updated in accordance with the received redefined information.

According to embodiments of the present invention, in order to easily develop not the software component directly installed in the ECU but the vehicle-IT application software such as navigation software or a black box, functions required from the vehicle-IT development viewpoint are classified as components to be used, so that the vehicle-IT application software is independently defined for a specific vehicle type and vehicle and a communication scheme for external interoperation, and thereby the software developers can concentrate on implementing functions of application programs, yielding high-quality software.

In addition, the prevent invention may be easily applied even to an existing vehicle which does not support the AUTOSAR.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as employed in Internet transmission. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for supporting development of software for vehicles, comprising:
a common interface that provides a communication connection with a vehicle application service development device for developing vehicle-IT-related application services; and
a common component management unit that manages a common component for configuring functional data of a vehicle used in developing the vehicle-IT-related application services as a component to be reused, and provides the common component to the vehicle application service development device through the common interface in response to a request from the vehicle application service development device.

2. The apparatus for supporting development of software for vehicles according to claim 1, further comprising:
a user input unit that receives a user input,
wherein the common component management unit registers a new common component in accordance with the user input, and updates an existing common component.

3. The apparatus for supporting development of software for vehicles according to claim 1, wherein the common component includes basic information of the common component, operation information used in the common component, dependence information indicating a relationship between the common component and another common component.

4. The apparatus for supporting development of software for vehicles according to claim 3, wherein the basic information of the common component includes a component name, a component type, component property, component-related keywords, and a component summary description.

5. The apparatus for supporting development of software for vehicles according to claim 3, wherein the operation information includes an operation name, an operation type, an operation description concerning a function of a corresponding operation, a return type defining parameters returned as a result of performing the corresponding operation, a return type description describing the return type, a name of a parameter used in the corresponding operation, a parameter data type indicating a data type for the parameter used in the corresponding operation, and a description for the parameter used in the corresponding operation.

6. The apparatus for supporting development of software for vehicles according to claim 5, wherein the common component management unit classifies the operation information used in the common component into a core module for performing a specific function, an output module for providing an operation and information for the common component to a GUI (Graphic User Interface), and an external library module including a library used when the specific function is performed in conjunction with an external device, and manages the classified operation information.

7. The apparatus for supporting development of software for vehicles according to claim 6, wherein the common component further includes source position information of the core module, source position information of a GUI module, and source position information of the external library module in order to enable reference and correction by a user.

8. The apparatus for supporting development of software for vehicles according to claim 3, wherein when related components are classified into a plurality of detailed components, the dependence information indicating the relationship between the common component and another component includes information indicating a relationship between the common component and the classified detailed component.

9. The apparatus for supporting development of software for vehicles according to claim 1, further comprising:
a device cooperative interface that receives device-related data dependent on a specific device required upon configuration of the component,
wherein the common component management unit transforms the common component into functional data that is executable in a device to perform the vehicle-IT-related application services, using the device-related data received through the device cooperative interface.

10. A method for supporting development of software for vehicles, comprising:
managing a common component for configuring functional data of a vehicle used in developing vehicle-IT-related application services as a component to be reused; and
providing the common component to a vehicle application service development device for developing the vehicle-IT-related application services in response to a request from the vehicle application service development device.

11. The method for supporting development of software for vehicles according to claim 10, further comprising:
registering the common component to be reused,
wherein the registering includes receiving basic information of the common component, operation information used in the common component, dependence information indicating a relationship between the common component and another common component, and a component-related file.

12. The method for supporting development of software for vehicles according to claim 11, wherein the basic information of the common component includes a component name, a component type, component property, component-related keywords, and a component summary description.

13. The method for supporting development of software for vehicles according to claim 11, wherein, in the managing, the operation information used in the common component is classified into a core module for performing a specific function, an output module for providing an operation and information for the common component to a GUI, and an external library module including a library used when the specific function is performed in conjunction with an external device, and the classified operation information is managed.

14. The method for supporting development of software for vehicles according to claim 11, further comprising:
updating the common component for configuring functional data of the vehicle used in developing the vehicle-IT-related application services as the component.

15. The method for supporting development of software for vehicles according to claim 14, wherein the updating includes performing at least one of an operation for redefining component basic information for an existing component, an operation for redefining the operation information for the component, and an operation for redefining dependence information for the component.
